(19) United States
(12) Patent Application Publication
(10) Pub. No.: US 2010/0278445 A1
(43) Pub. Date: Nov. 4, 2010

(54) GENERATING DATA USING A DATA ENCODING SYMBOL

(76) Inventor: Timothy Kindberg, Bristol (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/433,550

(22) Filed: Apr. 30, 2009

(51) Int. Cl. G06K 9/46

(52) U.S. Cl. 382/243

(57) ABSTRACT

A method for generating data using a data-encoding symbol comprising capturing an image of the data-encoding symbol using an imaging module of a device and generating symbol data therefrom representing the image, using the symbol data to generate a measure for at least one property of the symbol, and generating experience data in the device for determining parameters associated with the capture of the image, and a device suitable for implementing the method.

### BACKGROUND

Machine-readable optical symbols for encoding data can be used to link users to content and services via a camera-equipped device. The device can image the symbol using the camera and derive data from the image, which can be used to invoke a service or provide content. Such symbols can be in the form of barcodes for example, which can be one dimensional linear barcodes or two dimensional matrix codes or symbologies. Symbols such as barcodes can be monochrome or color.

Symbols can be counterfeit and the data encoded by the symbol can be modified. In order to counter this, authentication of symbols can be effected using custom readers and custom protocols when communicating with authentication services.

Symbols can also be deployed onto media not specifically designed or otherwise suitable for the symbol, such that it is not sufficiently well displayed or such that it can be difficult to discriminate for a user or device. As such the reading experience can be frustrating for a user, and difficult for a manufacturer to monitor and control.

### BRIEF DESCRIPTION OF THE DRAWINGS

Various features and advantages of the present disclosure will be apparent from the detailed description which follows, taken in conjunction with the accompanying drawings, which together illustrate, by way of example only, features of the present disclosure, and wherein:

FIG. 1 is a representation of an exemplary data symbol;

FIG. 2 is a schematic representation of a device used to capture an image of a data symbol such as that of that FIG. 1;

FIG. 3 is a representation of a data symbol showing aspects of the symbol which are used according to an embodiment;

FIG. 4 is a flow chart depicting steps for generating authentication data from an image of the symbol of FIG. 1;

FIG. 5 is a flow chart depicting the steps for generating data from an image of the symbol of FIG. 1.

### DETAILED DESCRIPTION

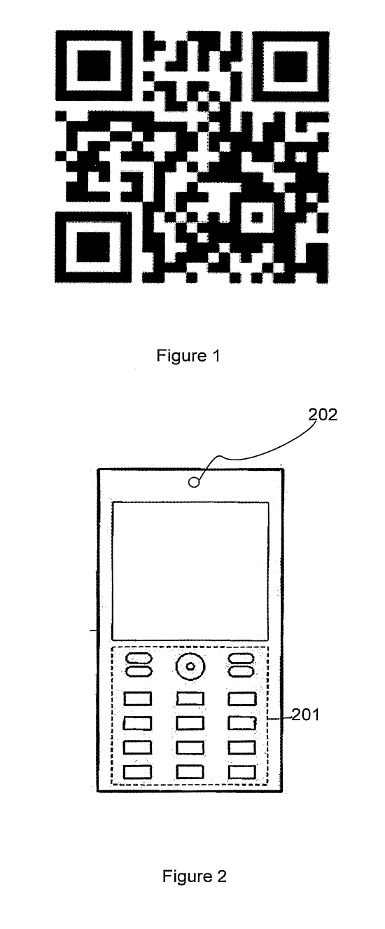

There are a large variety of 1D and 2D symbologies. For example, matrix codes, which feature square or dot-shaped modules (or elements) arranged on a grid pattern. An exemplary matrix code is depicted in FIG. 1. However, 2D symbologies also come in a variety of other visual formats such as those employing circular patterns, or those which employ steganography by hiding an array of different-sized or -shaped modules within a user-specified image. FIG. 1 is a schematic representation of a data symbol according to an embodiment. The data symbol 101 of FIG. 1 is a monochromatic two-dimensional (2D) barcode (or matrix code) suitable for printing onto a substrate, such as paper, plastic, glass or cardboard for example, or for displaying on a suitable display, such as an LED, LCD, CRT or other organic or inorganic display. Alternative substrates or displays can be used as will be appreciated by those skilled in the art, and the above is not intended to be limiting. The symbology depicted in FIG. 1 and more generally as described herein is not intended to be limiting, but is selected and described for the sake of brevity and clarity.

FIG. 2 is a schematic representation of a mobile device suitable for capturing an image of the barcode depicted in FIG. 1. The device 201 can be a dedicated device, that is to say, can be a device whose primary and possibly only function is the provision of capturing and processing images of data symbols. Alternatively, the device can be any suitable mobile device with imaging functionality. For example, the device can be a mobile telephone, personal digital assistant (PDA) or similar. The device depicted in FIG. 2 is in the form of a mobile telephone 201 which an imaging module 202. It will be appreciated that any suitable device can be used. The imaging module can be at the front of the device as depicted, or alternatively at the rear or on the side or in any other position on the device.

According to an embodiment, the device 201 is brought into the proximity of the symbol 101 by a user, such that the imaging module 202 has the symbol within its field of view. Imaging module 202 can be implemented in the device using any conventional system, including for example providing a digital camera comprising a charge-coupled device (CCD) or complementary metal-oxide-semiconductor (CMOS) sensor arranged to generate image data representative of a scene or subject within its field of view. Accordingly, the device can generate image data representative of the symbol being imaged.

In order to determine payload data encoded by the symbol, the image data is processed in order that the disposition of markings/colors/tones from which the symbol is composed is decoded. The processing of the image data can proceed according to known techniques in order to extract the payload data encoded by the symbol. Such data typically takes the form of a string of characters which can define a Universal Resource Identifier (URI), but can also be raw data representing something else, such as image data or other textual content for example.

According to an embodiment the data-encoding symbol printed on the substrate or displayed on a display is used to generate data. More specifically, an image of the data-encoding symbol is captured using the imaging module of the device and symbol data is generated therefrom, which symbol data represents the image of the data-encoding symbol. Using the symbol data it is possible to determine a number of properties of the symbol, as well as the payload data encoded by the symbol itself.

For example, the symbol data can be used to generate a measure for at least one property of the symbol as deployed on the substrate or as displayed such as the coloration of the symbol for example. More specifically, symbol data can be processed in order to determine a measure of the colors and/or tones in the elements from which the symbol is composed. The measure can be used to compare the coloration etc of the symbol against a known optimal case (for example the same or a similar symbol printed on a certified substrate using a certified printing process or displayed on a certified and/or calibrated display device). The symbol-specific data can therefore be used to determine if the symbol has been deployed in a way which is consistent and genuine (e.g. that the symbol is not counterfeit or otherwise deployed on sub-standard media using a sub-par printing process).

As mentioned, symbols can be deployed on displays such as electronic displays. Such displays can have their own intrinsic problems. For example, some displays can suffer from flicker, or the display proper can be housed behind glass which can cause glare for example. Such properties of electronic displays can adversely affect the reading of a displayed symbol which can be recorded in the symbol data. More specifically, when the symbol is imaged, artifacts caused as a result of the display mechanism can mean that the payload data can be difficult to decode due to the fact that the individual elements from which the symbol is composed can be obscured or otherwise affected. This can result in a failure to image the symbol, or errors in the process of imaging or decoding the symbol. In order to record this, the symbol data can be used to store information representing any failures, difficulties or other parameters associated with the symbol displayed on an electronic display.

According to an embodiment, the symbol data can also be used to generate reading-specific data in the device for determining parameters associated with the capture of the image. Such data can be termed experience data, as it relates to the experience that a user has gone through in order to image the data-encoding symbol. For example, the experience data can be used to record information representing the time taken for the device to image the symbol (including for example focusing and recording data). For example, the time taken to image a symbol can be the elapsed time between i) ‘suspecting’ a symbol to be present (e.g. on the basis of detecting registration indicia belonging to the symbology); and ii) extracting the payload of that same symbol (judged by the continuity of the symbol shape in the image for example).

The experience data can also be used to record information representing the relative conditions under which the capture occurred. For example, by determining a difference in the contrast between background and foreground elements of the image of the symbol, it can be determined if the ambient lighting was sufficient to enable the symbol to be imaged with the degree of accuracy and clarity required in order to determine the payload data encoded by the symbol, that is to say, if the individual elements of the symbol could be discriminated sufficiently from each other and the background to decode

The experience data can be used to record to information representing the capture of an image which is displayed on an electronic display. For example, properties of a display (such as flicker associated with the display, or glare caused by the display being housed behind a transparent screen) can affect the reading experience by making it difficult to image a symbol, or otherwise increase the time taken to suspect, register and image the symbol in an effective way.

The reading-specific data can therefore provide a measure representative of the conditions under which the image data was generated by the imaging module of the device. The experience data can be used to determine factors that indicate how challenging the imaging conditions were. Such factors can be measured in a number of ways. For example, by: the number of bits whose errors were corrected in the process of determining the payload data from the image data of the data-encoding symbol and/or the sharpness of the image.

Information representing the experience data can be communicated in a number of ways. According to an embodiment, the information can be communicated using URI templates which are known in the art. For example, using templates which allow arbitrary URIs to contain variables that can be bound to values, such as those described at http:H/tool.ietf.org/html/draft-gregorio-uritemplate-03.

Two exemplary URI templates are:

http://www.example.com/mobilecodes/3927?a={authentication}&e={err orcount}&c={contrast}; and

sms:07744229?body=code=37377?a=={authentication}&e={errorcount}&c={contrast}

The device can parse the URIs to determine the symbol keywords such as authentication, errorcount and contrast etc, and substitute the corresponding particular values found at read-time into the template. The resultant URI is then dereferenced as normal to invoke the service, for example.

Such URI templates can also be used to communicate the symbol-specific data as well as the reading-specific data, and no new protocol is required in order to communicate the data compared to standard code readers. A device, such as a code reader, simply has to know which predefined slots to fill with symbol-property and experience data, but the rest is the same as when reading a code containing a (non-template) URI. The service transparently processes any experience data and can respond accordingly if authentication fails.

As well as providing reading-specific information from the symbol data and the device, according to an embodiment, authentication data representing a variation in the color or tone of the symbol compared to control data encoding color or tone information for a control symbol when printed onto the same substrate as that of the symbol in question, or displayed on the same or a similar display can be determined using the symbol data. The authentication data can be used to verify the authenticity of the data-encoding symbol as will be described below. Data used for authentication need not be in the symbol proper, but can be disposed around the periphery of the symbol. For example, colored or monochrome cells can be disposed on the outside of a matrix symbol in order to encode authentication data.

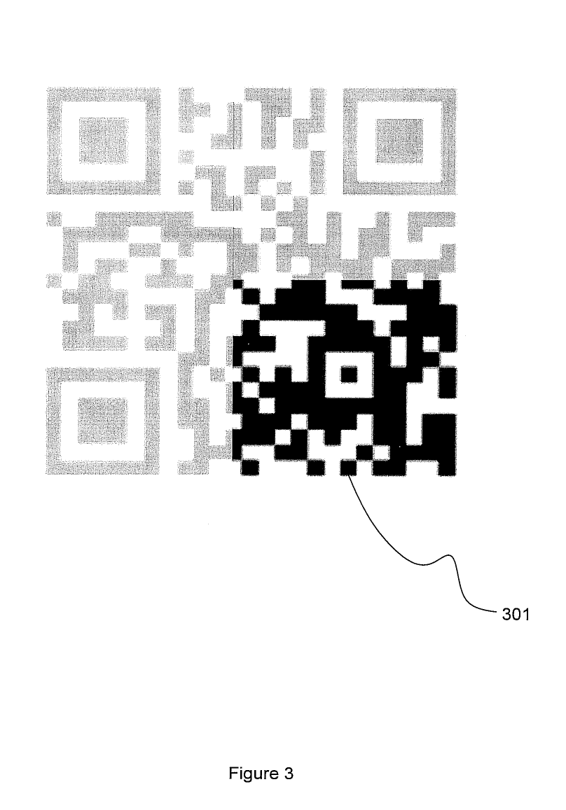

FIG. 3 shows an enlarged portion of the symbol of FIG. 1. The enlarged portion depicts the elements or cells 301 used to encode data for the symbol. It will be appreciated that it is possible to use color cells in the symbol to encode data. When the symbol of FIG. 1 is deployed onto a genuine or certified substrate using verified or standard printing processes, the symbol can be authenticated by the manufacturer and the end user (if appropriate) as genuine. That is to say, the quality and resolution of the symbol are controlled and can be assured such that a device can image the symbol and determine payload data without encountering issues caused by sub-standard printing processes or media. When a symbol is deployed using non-standard printing techniques onto a genuine or non-genuine substrate, the reproduction can be sub-standard, and it will be difficult to control and assure the quality and resolution of the symbol. Using non-standard printing processes either with certified or non-certified substrates will result in variations in the color and/or tone of the elements or components of the symbol used to encode data. The variations can cause problems when the symbol is imaged, since it may be difficult to properly discriminate between elements leading to a larger number of errors and possible failure to decode the payload data at all. Similarly, for a symbol displayed on an electronic display, problems associated with glare, flicker, reflections etc can be encountered, especially if the display is not optimized to minimize such problems.

When a symbol is deployed onto a certified (that is to say a genuine, quality) substrate using printing processes which are also certified (such as for example using a digital printing press, rather than a consumer grade printer), or is displayed on a suitable display (for example a display which has been optimized for the display of data-encoding symbols, such that flicker, reflections and glare for example are minimized) the distribution of colors and/or tones in the elements or components from which the symbol is composed is optimal in the sense that the contrast between the symbol and its constituent elements and between the symbol and the substrate is such that the symbol can be optimally imaged using the imaging module of a device. This will result in the best possible image data from which to determine the payload data encoded by the symbol.

A symbol printed on a certified substrate using a certified printing process, or displayed on an optimized disaply can be used to obtain control data. The control data can comprise information relating to the colors and/or tones of the symbol, and more specifically its constituent elements (i.e. in the case of a 2D matrix barcode, the dots and spaces that go to make up the symbol proper and encode the data). The control data represents information which describes the optimal color and/or tone distribution for a given symbol when deployed onto a given substrate using a certified printing process, or when displayed using an optimized display device.

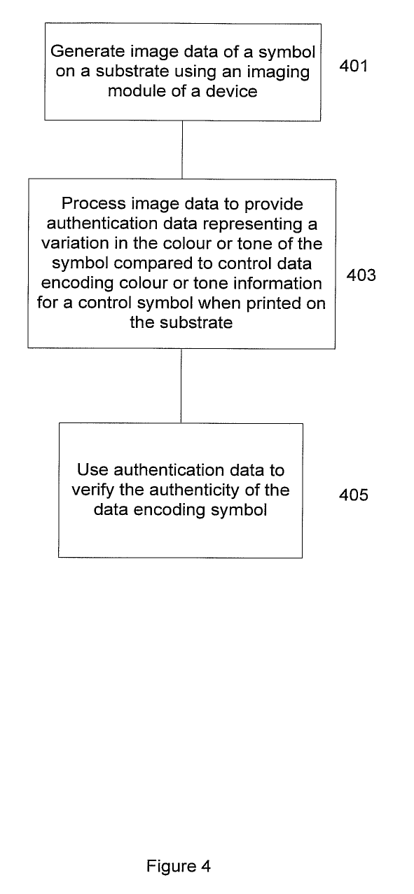

Referring to FIG. 4, which describes steps for generating authentication data for a data-encoding symbol, at step 401 image data is generated using an imaging module of a device. The image data represents an image of the data-encoding symbol. At step 403, the image data is processed in order to provide authentication data representing a variation in the color or tone of the symbol compared to control data encoding color or tone information for a control symbol. The processing can take place using a processor of the device, or can be performed remotely. For example, the image data can be stored in a memory of the device and transmitted to a remote processing station (such as a computer or server) either wirelessly using conventional wireless network connectivity of the device, or via a wired link, perhaps routed through the internet for example. In either case, it will be appreciated that the methods used for storage, transmission (if appropriate) and processing of the image data are known and need not be described in further detail.

As explained above, control data represents information which describes the optimal color and/or tone distribution for a given symbol when deployed onto a given genuine substrate using a certified printing process, or when displayed in an optimal way such as on an optimized display for example. Such control data can be stored in the device, or can be stored remotely so that it can be used when the image data has been generated and stored. Alternatively, the control data can be obtained from a remote storage location on-the-fly by the device as required.

At step 405 the authentication data is used to verify the authenticity of the data-encoding symbol. A comparison of the authentication data against control data for the same or a similar symbol gives a measure of the extent to which a variance occurs between the data-encoding symbol in question and one which has been deployed in an optimal fashion. If the measure is above a predefined threshold, the imaged symbol can be considered to be authentic. However, if the measure is at or below the threshold, the imaged symbol may be counterfeit.

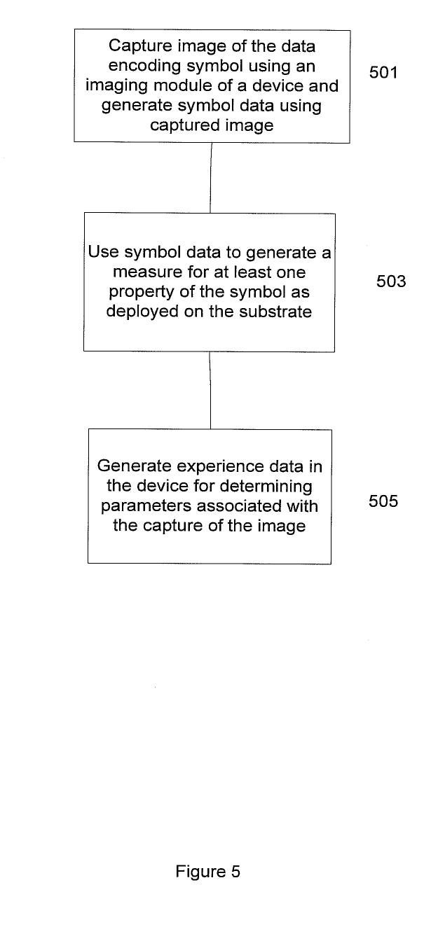

FIG. 5 depicts the steps for generating data from an image of a symbol. The symbol can be deployed on a substrate, or displayed on a suitable display. At step 501 an image of the data-encoding symbol is captured using an imaging module of a device and symbol data is generated therefrom. The symbol data represents the captured image. The symbol data can be processed, including correcting the white balance of the image, or by applying a sharpening algorithm for example. At step 503 the symbol data is used to generate a measure for at least one property of the symbol. The data generated at step 503 is symbol-specific data, such as data representing the color and/or tone of the symbol for example.

At step 505 experience data is generated in the device. The experience data is used for determining parameters associated with the capture of the image, and is reading-specific data relating to information such as the time taken to capture a symbol, and/or the conditions under which the symbol was imaged for example.

It is to be understood that the above-referenced arrangements are illustrative of the application of the principles disclosed herein. It will be apparent to those of ordinary skill in the art that numerous modifications can be made without departing from the principles and concepts of this disclosure, as set forth in the claims below.

What is claimed is:

1. A method for generating data using a data-encoding symbol comprising:
capturing an image of the data-encoding symbol using an imaging module of a device and generating symbol data therefrom representing the image;
using the symbol data to generate a measure for at least one property of the symbol; and
generating experience data in the device for determining parameters associated with the capture of the image.

2. A method as claimed in claim 1, wherein the generated measure comprises color data representing the coloration and/or tone of the symbol.

3. A method as claimed in claim 1, wherein the generated measure comprises sharpness data representing a measure of the sharpness or contrast of the image of the data-encoding symbol.

4. A method as claimed in claim 1, further comprising:
processing the symbol data in order to determine payload data encoded by the symbol, wherein the experience data comprises a measure of the number of bits of the payload data whose errors were corrected when determining the payload data.

5. A method as claimed in claim 1, wherein the experience data comprises a measure of the time taken to generate the symbol data.

6. A method as claimed in claim 5, wherein the measure of the time taken to generate the symbol data comprises the elapsed time between:
suspecting a symbol to be present on the basis of detecting registration indicia belonging to the symbology; and
extracting the payload data of the symbol.

7. A method as claimed in claim 2, further comprising:
comparing the color data with authentication data in order to determine a measure of the authenticity of the data-encoding symbol, the authentication data comprising predetermined data representing the coloration and/or tone of the symbol as deployed onto a predefined substrate or display.

8. A method as claimed in claim 1, wherein the experience data is used to track the quality of the symbol as displayed.

9. A device comprising an imaging module operable to generate symbol data representing an image of a data-encoding symbol, the device operable to encode payload data for the symbol derived from the symbol data with at least one of:
data representing a measure for at least one property of the symbol; and
experience data representing parameters associated with the capture of the image to provide output data.

10. A device as claimed in claim 9, wherein encoding the payload data is performed using a processing unit of the device, and wherein the output data is encoded in the form of an expanded Universal Resource Identifier (URI).

11. A device as claimed in claim 10, wherein the URI comprises a body and at least one embedded expansion for encoding the symbol data and experience data.

12. A device as claimed in claim 9, further comprising a wireless communication module configured to transmit the output data to a remote computing apparatus and to receive input data in response from the apparatus.

13. A device as claimed in claim 9, further operable to generate data representing the time taken to generate the symbol data.

14. A device as claimed in claim 13, wherein the data representing the time taken to generate the symbol data comprises data representing the elapsed time between:
suspecting a symbol to be present on the basis of detecting registration indicia belonging to the symbology; and
extracting the payload data of the symbol.

15. A computing apparatus operable to generate data using a data-encoding symbol by:
capturing an image of the data-encoding symbol using an imaging module of a device and generating symbol data therefrom representing the image;
using the symbol data to generate a measure for at least one property of the symbol as deployed; and
generating experience data in the device for determining parameters associated with the capture of the image.
